(19) United States
(12) Patent Application Publication
(10) Pub. No.: US 2015/0251521 A1
(43) Pub. Date: Sep. 10, 2015

(54) CLIMATE CONTROL SYSTEM FOR MACHINE CABIN

(71) Applicant: Caterpillar Inc., Peoria, IL (US)

(72) Inventors: Jason Matthew BRAUER, Peoria, IL (US); Kory LEESMAN, Hartsburg, IL (US)

(73) Assignee: Caterpillar Inc., Peoria, IL (US)

(21) Appl. No.: 14/200,769

(22) Filed: Mar. 7, 2014

(51) Int. Cl. B60H 1/32; B60H 1/00

(52) U.S. Cl. CPC B60H 1/3208; B60H 1/00742

(57) ABSTRACT

A climate control system is provided for use with a machine. The climate control system may have a compressor electrically powered to compress refrigerant, a condenser configured to dissipate heat from compressed refrigerant, and an evaporator configured to dissipate heat from chilled refrigerant to air directed into a cabin. The climate control system may also have at least one blower configured to selectively direct ambient air, cabin air, or a combination of ambient and cabin air through the evaporator, and a controller in communication with the engine, the compressor, and the at least one blower. The controller may be configured to determine a status of an engine, to determine existence of an operator in the cabin, and to selectively cause the at least one blower to direct only cabin air through the evaporator into the cabin when the engine is shut down and the operator is present in the cabin.

### TECHNICAL FIELD

The present disclosure relates generally to a climate control system and, more particularly, to a system for regulating the climate inside a machine cabin.

### BACKGROUND

Earth-working machines, such as cable shovels, excavators, wheel loaders, and haul trucks often operate in harsh conditions. These conditions can include extreme temperatures and dirty, dusty environments. In order to keep operators of these machines comfortable and to improve productivity of the machines, the cabins of these machine can be climate controlled. For example, the cabins can be pressurized to keep dust and debris out of the cabins, and the temperature of the cabins can be reduced via air conditioning.

A typical cabin air conditioner includes a compressor that is mechanically driven by an engine of the associated machine to compress a gaseous refrigerant. As the refrigerant is compressed, it becomes superheated. The superheated gas is then sent through a condenser where heat is transferred from the compressed refrigerant to the environment and the refrigerant changes state to a liquid. The cooled liquid refrigerant is then directed through an expansion valve where it is expanded back to its original pressure at a lower temperature, and then into an evaporator where it is allowed to absorb heat from air directed into the machine cabin. The absorbed heat causes the refrigerant to boil and change state back to a gas. The hot gas is then directed back to the compressor and the cycle begins again. In this configuration, the speed of the compressor is proportional to a cooling capacity of the system and tied directly to a speed of the engine. Accordingly, the only control over performance of the air conditioning system is the speed of the air directed through the evaporator into the cabin and whether the compressor is on or off Unfortunately, this limited control can result in unstable conditions within the machine cabin and low efficiency. In addition, a typical air conditioning system may not be operable unless the engine is running.

One attempt to improve climate control within a machine cabin is disclosed in U.S. Pat. No. 8,056,617 of Klassen et al. that issued on Nov. 15, 2011 (“the '617 patent”). Specifically, the '617 patent discloses an HVAC system having a pressurizing blower, a recirculating blower, and an air conditioning system that are coupled to an electronic circuit. The pressurizing blower is used to maintain an elevated pressure within the machine cabin. When high output of the air conditioning system is selected, the output of the pressurizing blower is automatically reduced and the output of the recirculating blower is proportionally increased. In this manner, greater control over the performance of the air conditioning system may be achieved.

Although perhaps an improvement over conventional air conditioning systems, the HVAC system of the '617 patent may still he less than optimal. In particular, the air conditioning system may still he belt driven by an engine of the machine and, accordingly, still suffer from the inefficiencies discussed above. And the HVAC system of the '617 patent may only be operable when the engine of the machine is turned on.

The disclosed climate control system is directed to overcoming one or more of the problems set forth above.

### SUMMARY

According to one exemplary aspect, the present disclosure is directed to a climate control system for a machine having an engine and a cabin. The climate control system may include a compressor electrically powered to compress a refrigerant, a condenser configured to dissipate heat from compressed refrigerant to the atmosphere, and an evaporator configured to dissipate heat from chilled refrigerant to air directed into the cabin. The climate control system may also include at least one blower configured to selectively direct ambient air, cabin air, or a combination of ambient and cabin air through the evaporator and into the cabin, and a controller in communication with the engine, the compressor, and the at least one blower. The controller may he configured to determine a status of the engine and existence of an operator within the cabin. The controller may also be configured to selectively cause the at least one blower to direct only cabin air through the evaporator and into the cabin when the engine is shut down and the operator is present within the cabin.

According to another exemplary aspect, the present disclosure is directed to a method of cooling a cabin of a machine having an engine and a climate control system with a compressor, an evaporator, and at least one blower. The method may include determining a status of the engine and existence of an operator within the cabin. The method may further include selectively causing the at least one blower to direct only cabin air through the evaporator and into the cabin when the engine is shut down and the operator is present within the cabin.

### BRIEF DESCRIPTION OF THE DRAWINGS

FIG. 1 is an isometric illustration of an exemplary disclosed machine;

FIG. 2 is an diagrammatic illustration of an exemplary disclosed climate control system that may be used in conjunction with the machine of FIG. 1;

FIG. 3 is a flowchart depicting an exemplary disclosed method that may be performed by the climate control system of FIG. 2.

### DETAILED DESCRIPTION

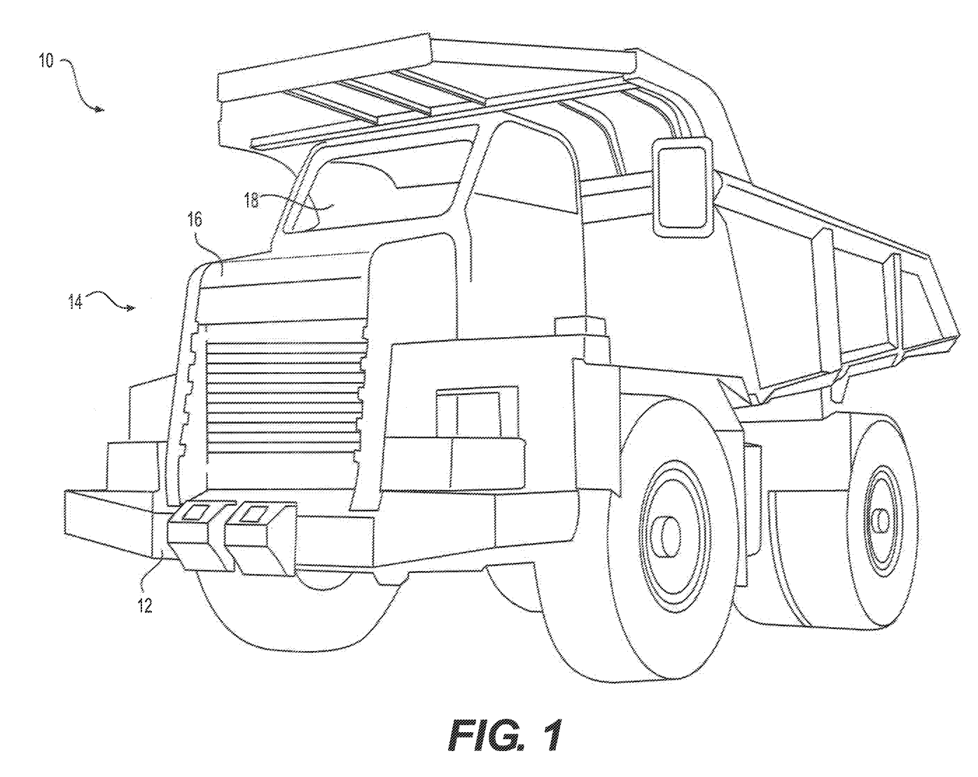

FIG. 1 illustrates an exemplary embodiment of a machine 10. Machine 10 may be a mobile machine that performs some type of operation associated with an industry such as mining, construction, farming, transportation, or another industry known in the art. For example, machine 10 may be an earth moving machine such as the haul truck shown in FIG. 1, a motor grader, a track-type tractor, a wheel loader, or another type of mobile machine.

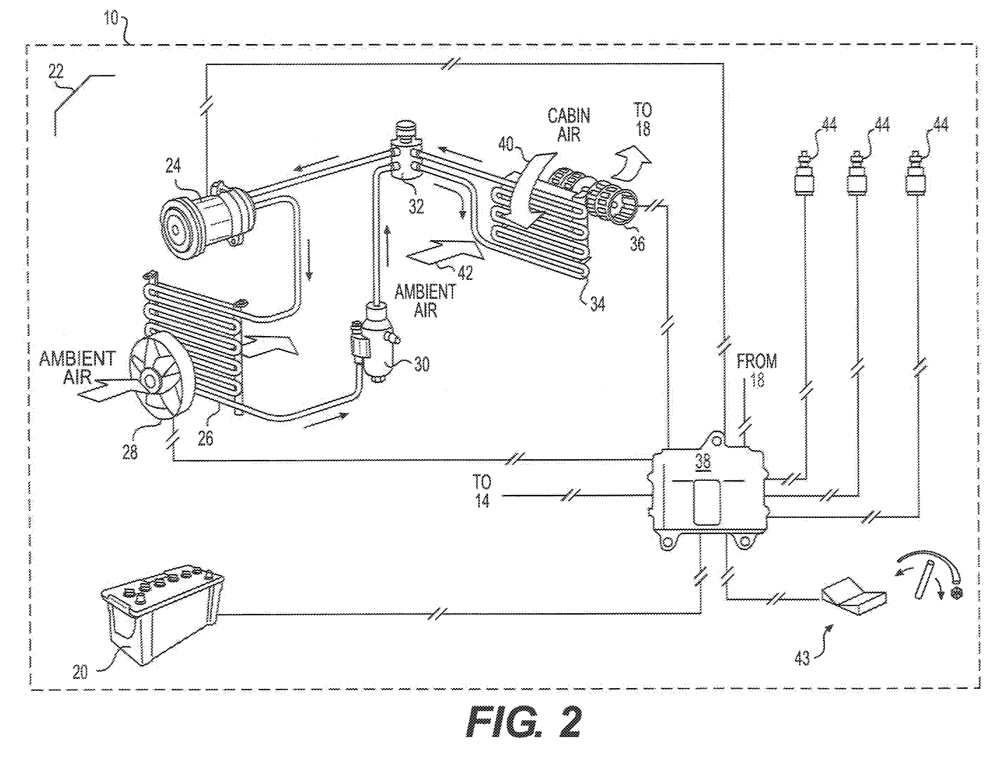

Machine 10 may include a frame 12, an engine 14 connected to frame 12 and located within an enclosure 16, and an operator cabin (“cabin”) 18 supported by frame 12. Engine 14 may be, for example, an internal combustion engine that produces a power output used to propel machine 10 and power auxiliary systems of machine 10. The power output may include any combination of an electrical output, a hydraulic output, and a mechanical output. In some embodiments, excess electrical power produced by engine 14 may be stored within a battery 20 (shown only in FIG. 2) or other similar device. Enclosure 16 may be provided with one or more air inlets that are configured to pass ambient air into enclosure 16 for combustion purposes within engine 14 and, in some instances, also for purposes of cooling cabin 18, which will be described in more detail below.

As shown in FIG. 2, machine 10 may be equipped with a climate control system (CCS) 22 that facilitates cooling of cabin 18. CCS 22 may take one of multiple different configurations known in the art. In a first configuration, CCS 22 is located at least partially within enclosure 16 (referring to FIG. 1) and configured to share the air flow directed through the inlets of enclosure 16. In this embodiment, the different components of CCS 22 may be mounted to frame 12, engine 14, and/or walls of enclosure 16 and spread apart from each other. In a second embodiment, CCS 22 may be relatively modular, with most components packaged together within a dedicated housing (not shown). The housing may be disposed at any convenient location on machine 10, for example on a roof or at a rear panel of cabin 18, and have its own air inlets dedicated for use in cooling cabin 18.

Regardless of the specific configuration of CCS 22, the components of CCS 22 may be coupled to each other and cooperate to cool cabin 18. These components may include, among other things, a compressor 24, a condenser 26, a fan 28, a filter/dryer 30, an expansion valve 32, an evaporator 34, one or more blowers 36, and a controller 38. Compressor 24 may compress a gaseous refrigerant (e.g., R12, R134a, HFO-1234yf, etc.) until it becomes superheated. The superheated gas may then be sent through condenser 26, where heat is transferred from the compressed refrigerant to an ambient air flow generated by fan 28 and the refrigerant changes state to a liquid. The cooled liquid refrigerant may then be directed through filter/dryer 30 where debris and water in the refrigerant is removed, and then through expansion valve 32 where the refrigerant is allowed to expand at a controlled rate. From expansion valve 32, the liquid refrigerant may then he directed into evaporator 34 where the refrigerant absorbs heat from air (from a fresh ambient air flow, a recirculated cabin air flow, or a mix of fresh and recirculated air) generated by blower(s) 36 and directed into cabin 18. The absorbed heat may cause the refrigerant to boil and change state back to a gas. The hot refrigerant gas may then be directed back through expansion valve 32 to compressor 24, where the cycle may begin again. Controller 38 may regulate operation of compressor 24, fan 28, and/or blower(s) 36 to vary a pressure of cabin 18, a temperature of cabin 18, and/or a power consumption of CCS 22.

Compressor 24, in the disclosed embodiment, is electrically powered by engine 14 (i.e., by electricity generated through operation of engine 14) and/or stored within battery 20. Compressor 24 may be selectively activated (i.e., turned on and off) by controller 38 to compress refrigerant, and a speed of compressor 24 may be varied through command signals from controller 38. It is contemplated that compressor 24 may be powered by only electricity or alternatively powered by both electricity and a mechanical or hydraulic connection (not shown) with engine 14, as desired.

Fan 28, in the disclosed embodiment, may also be powered by electricity that is generated through operation of engine 14 and/or stored within battery 20. And like compressor 24, fan 28 may be selectively activated by controller 38. For example, fan 28 may be activated anytime that compressor 24 is also activated. Additionally or alternatively, fan 28 may be activated based on a temperature of the refrigerant within CCS 22. It is contemplated that a speed of fan 28 may be a fixed speed, that fan 28 may have multiple different speed levels that are selected based on an operation of CCS 22, and/or that the speed of fan 28 may be continuously varied. It is also contemplated that fan 28 may be dedicated to generating an ambient air flow directed only through evaporator 34, or that fan 28 may embody a general-use fan also associated with cooling of engine 14 and/or other components of machine 10.

Blower(s) 36 may be configured to draw air from any combination of two different sources, pressurize the air, and direct the air through evaporator 34, and into cabin 18. In the depicted example, CCS 22 includes a single blower 36 configured to selectively draw air from one or both of a recirculated cabin air inlet 40 and from a fresh ambient air inlet 42. Inlets 40, 42 may be selectively opened, closed, metered, and/or diverted in connection with operation of the single blower 36 to provide only fresh air, only recirculated cabin air, or a mix of fresh and recirculated air into cabin 18, as desired. In another example (not shown), CCS 22 includes two separate blowers 36, each dedicated to a single air inlet (e.g., a first blower 36 for cabin air inlet 40 and a second blower for ambient air inlet 42). For the purposes of this disclosure, the term “blower” is to be interpreted as any combination of a flow-inducing device, valve, diverter, and/or actuator that functions to selectively draw air from inlet 40, from inlet 42, or from a combination of both inlets 40, 42, and direct the air through evaporator 34 and into cabin 18. As will be described in more detail below, blower(s) 36 may selectively be used together with the remaining components of CCS 22 to cool cabin 18 or alone to only pressurize cabin 18 without significantly affecting a temperature of cabin 18. Blower(s) 36 may be used during most machine operations to maintain an elevated pressure within cabin 18 (i.e., a pressure elevated above the outside environmental pressure so as to inhibit ingress of dust and debris), and only selectively used to cool cabin 18.

Controller 38 may be configured to regulate operation of compressor 24, fan 28, and/or blower(s) 36. Controller 38 may embody a single processor or multiple processors that include a means for controlling an operation of CCS 22. Numerous commercially available processors may perform the functions of controller 38. Controller 38 may include or be associated with a memory for storing data such as for example, an operating condition, design limits, performance characteristics or specifications of CCS 22, operational instructions, and corresponding settings of compressor 24 and/or blower(s) 36. This data may be stored within the memory of controller 38 in the form of one or more lookup tables, as desired. Various other known circuits may be associated with controller 38, including power supply circuitry, signal-conditioning circuitry, solenoid driver circuitry, communication circuitry, and other appropriate circuitry. Moreover, controller 38 may be capable of communicating with any components of CCS 22 and/or other components of machine 10 (e.g., with engine 14) via either wired or wireless transmission.

Controller 38 may rely on operator input received via one or more control devices 43 located within cabin 18 and/or based on signals from one or more sensors 44 to determine the conditions of cabin 18 used as a basis for controlling compressor 24, fan 28, and/or blower(s) 36. Control devices 43 may include, for example, any combination of an activation button associated with operation of CCS 22, a switch associated with selection of an automated or manual mode, and/or a dial for indicating a desired setting (e.g., temperature and/or blower speed) of CCS 22. Other or different control devices may also be utilized. Sensors 44 may include, for example, any combination of a seat belt sensor, a seat pressure sensor, an ambient air temperature sensor, a cabin air temperature sensor, a cabin air pressure sensor, an engine speed sensor, an available power sensor, etc. Signals generated by control devices 43 and sensor(s) 44 may be directed to controller 38 for further processing. It is contemplated that controller 38 may directly reference values of these signals with the lookup tables stored in memory to determine corresponding settings of compressor 24, fan 28, and/or blower(s) 36, or controller 38 may alternatively use values of the signals to calculate other parameters that are then referenced with the lookup tables, as desired.

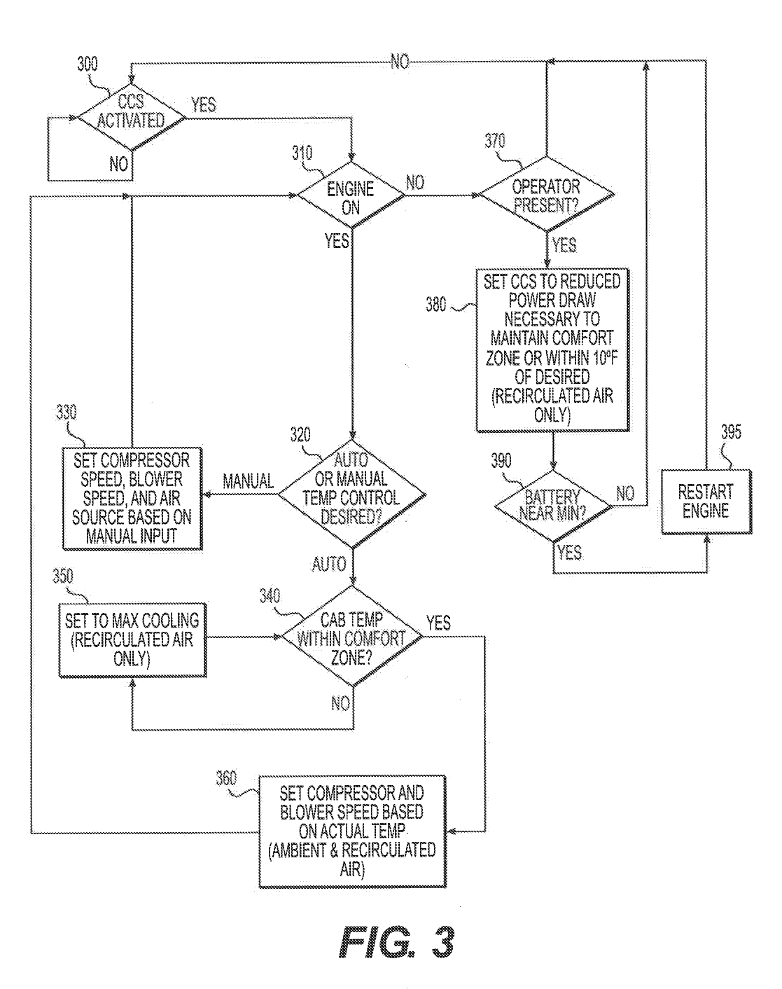

FIG. 3 illustrates an exemplary method performed by controller 38 during cooling of cabin 18. FIG. 3 will be discussed in more detail below to further illustrate the disclosed concepts.

### INDUSTRIAL APPLICABILITY

The disclosed climate control system may be applicable to any machine having an operator cabin. The disclosed climate control system may be configured to cool and pressurize the operator cabin with increased functionality and increased efficiency. The functionality of the disclosed climate control system may be increased through the ability to cool the cabin during temporary engine shutdown. The efficiency may be increased by coordinating cabin pressure control and condenser operation with an amount of available power. Operation of CCS 22 will now be described in detail.

As shown in FIG. 3, operation of CCS 22 may begin with operation of engine 14. In particular, controller 38 may be activated by or otherwise periodically check the status of engine 14 (Step 300). Controller 38 may check the status of engine 14 by sensing a rotational speed of engine 14 (e.g., via an engine speed sensor 44) or in another manner known in the art. When the speed of engine 14 is above a threshold speed (e.g., greater than zero), controller 38 may conclude that engine 14 is on. Otherwise, controller 38 may conclude that engine 14 is shut down.

Operation may begin when controller 38 determines that CCS 22 has been activated (Step 300). CCS 22 may be activated manually by an operator by an operator of machine 10 via any one or more of control device(s) 43 located within cabin 18. For example, the operator may depress a button signaling for cooling of cabin 18 to begin, and/or turn a dial to indicate a desired temperature and/or blower speed. Alternatively, the operator may only turn CCS 22 on, and the temperature and blower speed may be automatically designated to produce a predefined comfort zone within cabin 18. In this latter example, the predefined comfort zone may be defined as a predetermined temperature range (e.g., about 70-85° F.) that is intended to provide an acceptable working environment for the operator. In yet another embodiment, CCS 22 may be automatically activated without any operator input, for example upon startup of machine 10. Control may loop through step 300 until CCS 22 is determined to be active. Controller 38 may then determine if engine 14 is on (Step 310).

When engine 14 is determined at step 310 to be on, controller 38 may determine if automatic or manual control over the temperature within cabin 18 is desired (Step 320). The type of control desired by the operator may be indicated, for example, by way of input devices 43. When manual control is desired, controller 38 may set the speed of compressor 24, the speed of blower(s) 36, the speed of fan 28, and the source of air for blower(s) 36 directly based on manual input received via input devices 43 (Step 330). For example, the operator of machine 10 may indicate a desire for low temperature and medium air flow. The low temperature setting may cause compressor 24 and fan 28 to operate at high speed, and for blower(s) 36 to operate at a medium speed setting. In addition, the air being directing into cabin 18 may be a mix of fresh ambient air and recirculated air and cabin 18 may be pressurized at this time. During manual control over cooling of cabin 18, blower(s) 36 may be configured to recirculate cabin air only during a maximum setting of the input device. During all other manual control settings less than the maximum setting, blower(s) 36 may draw in and pressurize ambient air only or a mix that includes at least some ambient air so as to elevate the pressure within cabin 18 and thereby inhibit the ingress of dirt and debris. Regardless of the temperature within cabin 18, the parameters of compressor 24, fan 28, and blower(s) 36 may remain about the same and related to the manual input received via input devices 43. Control may return from step 330 to step 310.

Returning to step 320, when controller determines that automatic control over cabin conditions is desired, controller 38 may determine if the current temperature within cabin 18 is within the predefined comfort zone (Step 340). If the temperature within cabin 18 exceeds the predefined comfort zone, controller 38 may set CCS 22 for maximum cooling (Step 350). At this setting, compressor 24 may be commanded to operate at a maximum speed, and blower(s) 36 may be set at a maximum air flow rate. In addition, blower(s) 36 may be controlled to draw air from only cabin air inlet 40 when CCS 22 is set for maximum cooling. In other words, CCS 22 may be caused to recirculate air from cabin 18 back into cabin 18. CCS 22 may be able to induce lower temperatures within the air flow entering cabin 18 when recirculating air that has already been cooled somewhat than when directing warmer ambient air through evaporator 34, although a pressure of cabin 18 may be lower.

If at step 340, controller 38 determines that the temperature within cabin 18 is within the comfort zone, controller 38 may selectively command compressor 24 and blower(s) 36 to operate at levels corresponding to the actual temperature within cabin 18 (Step 360). For example, at higher cabin temperatures, the speeds of compressor 24 and/or blower(s) 36 may be increased. In one instance, the values of these speeds may be determined through reference of the actual temperature (together with the desired temperature or alone) with a lookup table stored in memory. It should be noted that other strategies for determining the settings of compressor 24 and/or blowers (36) may be used at step 360, if desired. In addition to setting the compressor and/or blower speeds to values based on the actual temperature, controller 38 may also cause blower(s) 36 to pressurize cabin 1$ (Step 335). In other words, controller 38 may cause blower(s) 36 to draw air from only ambient air inlet 42 or from both ambient and cabin air inlets 42, 44 so as to help keep dust and debris from entering cabin 18. The particular mixture of fresh and recirculated air may be dependent on the temperature with cabin 18, such that at high temperatures more recirculated air is used than at lower temperatures.

Returning to step 310, when controller 38 determines that engine 14 is off, controller 38 may then determine the existence of the operator within cabin 18 (Step 370). In particular, it may be possible for the operator to remain within cabin 18 even when engine 14 has been shut down. For example, in some situations the engine may be automatically shut down to save fuel during an extended idling operation while machine 10 is being loaded or unloaded. And the temperature of cabin 18 should still be controlled in these situations. In some instances, controller 38 may be forewarned of engine shutdown, allowing time for controller 38 to make adjustments to the operation of CCS 22 in advance of the shutdown.

Controller 38 may determine the existence of the operator within cabin 18 in any number of different ways. In one embodiment, controller 38 may determine that the operator is still within cabin 18 when the operator is wearing a seat belt. For example, a seat belt sensor 44 may generate a signal directed to controller 38 indicating such a condition. In another example, a seat pressure sensor 44 may be able to generate a signal indicative of a weight above a threshold amount resting on an associated seat within cabin 18. Other ways to determine the existence of the operator within cabin 18 may also be possible. If the operator is not within cabin 18 following shutdown of engine 14, control may return to step 300.

When the operator is still inside cabin 18, controller 38 may then set CCS 22 to operate at a reduced power draw. In particular, controller 38 may set CCS 22 to operate a level necessary to only maintain temperatures of cabin 18 within the comfort zone and/or within about 10° F. of a desired temperature (Step 380). At this same time, controller 38 may cause blower(s) 36 to draw recirculated air from only cabin air inlet 40 in an attempt to improve cooling during engine shutdown. In some instances, the reduced power level may be a fixed level (e.g., a fixed compressor speed and/or blower speed less than a maximum speed) that does not vary with cabin temperature. For example the reduced power level may include a minimum speed of compressor 24 and/or blower(s) 36. In other instances, however, the reduced power level may still vary with temperature, but still be a level less than would normally be used during engine operation. It should be noted that temperatures may rise during engine shutdown when CCS 22 is operated at the reduced level. However, the latter example, adjustments may be made to compressor, fan, and/or blower speeds during this time to help maintain temperatures within the comfort zone and/or within 10° F. of the desired temperature.

When cooling cabin 18 during engine shutdown, care should be taken so that CCS 22 does not consume too much stored power. Specifically, it may be possible for CCS 22 to draw enough power from battery 20 during the shutdown period to inhibit engine 14 from being restarted (and/or to inhibit other machine operations from being performed). Accordingly, when cooling cabin 18 during engine shutdown, controller 38 may monitor the charge within battery 20 to determine if a minimum amount of charge is still available (Step 390). When the charge within battery 20 nears the minimum amount (i.e., is within a threshold amount of the minimum charge), controller 38 may cause engine 14 to automatically restart (Step 395). Restarting engine 14 may allow charging of battery 20. Control may return from step 395 to step 300.

In some applications, controller 38 may be aware of or otherwise be able to anticipate machine operations that require a significant amount of stored battery power. In these instances, controller 38 may adjust the level at which engine 14 is restarted and/or the power draw of CCS 22, such that enough stored power remains within battery 20 for these other operations. If at step 390, it is determined that battery 20 still retains more than enough power to restart engine 14 (and, in some instances, provide for other non-HVAC related operations), controller 38 may continue to cool cabin 18 at the reduced power level (or further reduce the power level) and control may return to step 300.

The disclosed climate control system may have many benefits. In particular, because the components of CCS 22 may be electrically powered, engine 14 may not need to be operational for cabin 18 to be cooled. In addition, the speed of the different components may be regulated to provide a desired performance, regardless of a speed or state of engine 14. And this may help to improve efficiency.

It will be apparent to those skilled in the art that various modifications and variations can be made to the disclosed climate control system. Other embodiments will be apparent to those skilled in the art from consideration of the specification and practice of the disclosed climate control system. It is intended that the specification and examples be considered as exemplary only, with a true scope being indicated by the following claims and their equivalents.

What is claimed is:

1. A climate control system for a machine having an engine and a cabin, the climate control system comprising:
a compressor electrically powered to compress a refrigerant;
a condenser configured to dissipate heat from compressed refrigerant to the atmosphere;
an evaporator configured to dissipate heat from chilled refrigerant to air directed into the cabin;
at least one blower configured to selectively direct ambient air, cabin air, or a combination of ambient and cabin air through the evaporator and into the cabin; and
a controller in communication with the engine, the compressor, and the at least one blower, the controller being configured to:
determine a status of the engine;
determine existence of an operator within the cabin; and
selectively cause the at least one blower to direct only cabin air through the evaporator and into the cabin when the engine is shut down and the operator is present in the cabin.

2. The climate control system of claim 1, wherein the controller is further configured to selectively reduce a speed of the compressor when the engine is shut down and the operator is present in the cabin.

3. The climate control system of claim 2, further including a sensor configured to sense a temperature in the cabin, wherein the controller is further configured to selectively adjust a speed of the compressor based on a signal from the sensor.

4. The climate control system of claim 3, wherein the controller is configured to:
selectively adjust the speed of the compressor based on the signal when the engine is running; and
selectively reduce the speed of the compressor when the engine is shut down and the operator is present in the cabin.

5. The climate control system of claim 4, wherein the controller is configured to reduce the speed of the compressor to a minimum speed.

6. The climate control system of claim 3, wherein the controller is further configured to:
determine if the temperature in the cabin is within a predefined comfort zone based on the signal; and
selectively cause the at least one blower to direct a mixture of ambient air and cabin air through the evaporator and into the cabin when the temperature is within the comfort zone while the engine is running.

7. The climate control system of claim 6, wherein the controller is further configured to selectively increase the speed of the compressor to a maximum speed when the temperature exceeds the comfort zone and the engine is running.

8. The climate control system of claim 6, wherein the controller is further configured to selectively cause the at least one blower to direct only cabin air through the evaporator and into the cabin when the temperature exceeds the comfort zone and the engine is running.

9. The climate control system of claim 6, wherein:
the controller is further configured to receive input indicative of a desire for manual control over cooling of the cabin;
selectively set a speed of the compressor and a speed of the at least one blower to values based directly on the input; and
selectively cause the at least one blower to draw in and pressurize a mixture of ambient air and cabin air based directly on the input.

10. The climate control system of claim 9, wherein:
the controller is further configured to determine when the input indicates desired maximum cooling; and
responsively set the at least one blower to draw in and pressurize only cabin air.

11. The climate control system of claim 6, wherein the controller is further configured to:
adjust operation of the at least one of the compressor and the at least one blower based on the temperature of the cabin only during automated temperature control when the temperature is within the comfort zone; and
adjust operation of the at least one of the compressor and the at least one blower based directly on the input only during manual temperature control when the temperature is within the comfort zone.

12. The climate control system of claim 2, wherein the controller is further configured to:
determine an amount of stored power available to the climate control system during shutdown of the engine when the operator is present in the cabin; and
selectively start the engine based on the amount of stored power.

13. The climate control system of claim 12, wherein the controller is configured to selectively start the engine when the amount of stored power is within a threshold amount of a minimum value required to restart the engine.

14. A method of cooling a cabin of a machine having an engine and an air conditioning circuit with a compressor, an evaporator, and at least one blower, the method comprising:
determining a status of the engine;
determining existence of an operator within the cabin; and
selectively causing the at least one blower to direct only cabin air through the evaporator into the cabin when the engine is shut down and the operator is present within the cabin.

15. The method of claim 14, further including selectively reducing a speed of the compressor when the engine is shut down and the operator is present within the cabin.

16. The method of claim 15, further including:
sensing a temperature in the cabin; and
selectively adjusting a speed of the compressor based on the temperature.

17. The method of claim 16, further including selectively fixing the speed of the compressor Co a value less than a maximum speed when the engine is shut down and the operator is present within the cabin.

18. The method of claim 16, further including:
determining if the temperature in the cabin is within a comfort zone; and
selectively causing the at least one blower to direct a mixture of ambient air and cabin air through the evaporator and into the cabin when the temperature is within the comfort zone while the engine is running.

19. The method of claim 18, further including selectively increasing the speed of the compressor to a maximum speed and causing the at least one blower to selectively direct only cabin air through the evaporator and into the cabin when the temperature exceeds the comfort zone, the engine is running, and the operator is present within the cabin.

20. A machine, comprising;
a frame;
a cabin connected to the frame;
an engine supported by the frame and configured to propel the machine;
a compressor electrically powered by the engine to compress a refrigerant;
a condenser configured to dissipate heat from compressed refrigerant to the atmosphere;
an evaporator configured to dissipate heat from chilled refrigerant to air directed into the cabin;
at least one blower configured to selectively direct ambient air or cabin air through the evaporator and into the cabin;
a first sensor configured to sense a temperature in the cabin;
a second sensor configured to sense existence of an operator in the cabin; and
a controller in communication with the engine, the compressor, the at least one blower, the first sensor, and the second sensor, the controller being configured to:
selectively adjust a speed of the compressor based on a signal from the first sensor when the engine is running;
determine a status of the engine;
determine existence of an operator within the cabin based on the second sensor; and
selectively reducing a speed of the compressor when the engine is shut down and the operator is present in the cabin.
